(19) United States
(12) Patent Application Publication
(10) Pub. No.: US 2008/0095969 A1
(43) Pub. Date: Apr. 24, 2008

(54) CD, DVD disc protector

(76) Inventors: Johnny L. Brown, Temple Hills, MD (US); Charles A. Butler, Orlando, FL (US)

Correspondence Address: Steven L. Stephan, 958 Nicklaus Dr., Newport News, VA, 23602, US

(21) Appl. No.: 11/983,132

(22) Filed: Nov. 8, 2007

Related U.S. Application Data
(62) Division of application No. 11/210,844, filed on Aug. 25, 2005.
(60) Provisional application No. 60/604,788, filed on Aug. 27, 2004.

(51) Int. Cl. B32B 3/02

(52) U.S. Cl. 428/66.7

(57) ABSTRACT

This invention discloses a protective disc and structure to hold an optical data disc to the protective disc so that if the during use the combination of the data disc and protective disc are mishandled the protective disc does not permit the data to become scratched. Instead the protective disc might become scratched. The data disc is held to the protective disc in a releasable fashion so that it can be removed from the protective disc and attached to another if the first protective disc becomes scratched. The data disc can be held to the protective disc by a band which extends entirely around the circumference of a data disc. The band can be comprised of two semicircular rings which are held together by hinges and/or by clasps so that as the semicircular rings are brought together they surround the edges of the protective disc and the data disc and hold the discs together. Alternatively, the band can be made of a continuous ring of heat shrink material. In this instance the band is applied around both the protective disc and the data disc, and then heat is supplied so as to shrink the band around the discs and hold them together.

This application is a division of Ser. No. 11/210,844, filed Aug. 25, 2005, and which is in turn entitled to priority from provisional application 60/604788, filed Aug. 27, 2004 under 35 USC 120.

This invention relates to a protective disc which protects a CD or DVD from scratches.

### PRIOR ART

A problem with CD and DVD discs is they are easily scratched or marred to the point of not being readable by a CD or DVD player. When a scratched or marred CD or DVD disc is no longer readable by a CD or DVD player, the unreadable CD or DVD disc must be thrown away.

One solution to the above problem has been to place a transparent protective cover over the surface of a CD or DVD disc and hold it in place by means of annular rings of adhesive at the inside and outside of the disc as disclosed by U.S. Pat. No. 4,879,710. This system has the drawback that the protective disc is thin and relatively fragile. It must be protected itself by means of a release sheet before being applied to the CD or DVD. Then during application it is sometimes difficult to maintain the protective disc in a rigid condition so that as the thin protective sheet is applied to the CD or DVD, it can accidentally become wrinkled or folded, and in the process unusable if surfaces with adhesive come into contact with each other.

### ADVANTAGES OF THE INVENTION

This invention of this application overcomes the problems of the prior art by means of a transparent protective disc for a CD or DVD that is held in position on the CD or DVD by means of a mechanical holding or latching means. The protective disc is usually about half the thickness of a CD or DVD disc, however any thickness would be permissible as long as the data on the CD or DVD disc can be read through the disc protective cover, and the cover remains sufficiently rigid to hold its shape.

By means of the protective disc being attached mechanically, if this mechanical means is designed properly, it is possible to provide a protective disc which can be removed from one CD or DVD and placed on a different CD or DVD if desired, without destroying the protective disc, and it can be applied to a new or different CD or DVD. From this it is apparent that device of this invention provides a protective disc which is much more flexible in its use.

### DRAWINGS

Exemplary embodiments of the invention are shown in the drawings, in which:

FIGS. 1-1b show an embodiment in which a rigid transparent protective disc is held to a CD or DVD by means of a first semicircular ring which is attached to the protective disc, and a second semicircular ring which is held to the first semicircular ring by box clasps. FIG. 1a shows a section taken through the vertical plane that includes line A-A of FIGS. 1 and lb shows a section through the vertical plane that includes line B-B of FIG. 1. FIGS. 1a and 1b are not drawn to scale;

FIG. 2 shows a modification in which one of the semicircular rings is attached to the protective disc and the other is attached at one end to an end of the first by a hinge;

FIG. 3 shows a modification in which neither of the semicircular rings are attached to the protective disc;

FIG. 4 shows a modification in which neither of the semicircular rings is attached to the protective disc, however, the semicircular rings are attached to each other at one end of each by a hinge;

FIGS. 5 and 5a show an embodiment in which the ring is a single, flexible piece and the protective disc is separate from it, wherein FIG. 5 is schematic showing, and FIG. 5a shows a section through the vertical plane that includes line C-C of FIG. 5, and is enlarged for clarity;

FIGS. 6 and 6a show an alternative in which the ring is made of heat shrink material. FIG. 10a shows a section through the vertical plane that includes line D-D of FIG. 6, and is enlarged for clarity; and

FIGS. 7, 7a, and 7b show a box clasp locking mechanism. FIG. 7 shows a box clasp tongue with thumb piece. FIG. 7a shows a box clasp hole. FIG. 7b shows both box clasp tongue and hole mated. The box clap tongue has an outward pressure that presses inward as it mates with the box clasp hole. When the thumb of the box clap tongue mates with the box clasp hole, the box clasp tongue presses outward locking the two pieces together. To unlock the two pieces, press in on the thumb of the box clasp tongue and pull the two pieces apart.

### DESCRIPTION OF THE EXEMPLARY EMBODIMENTS

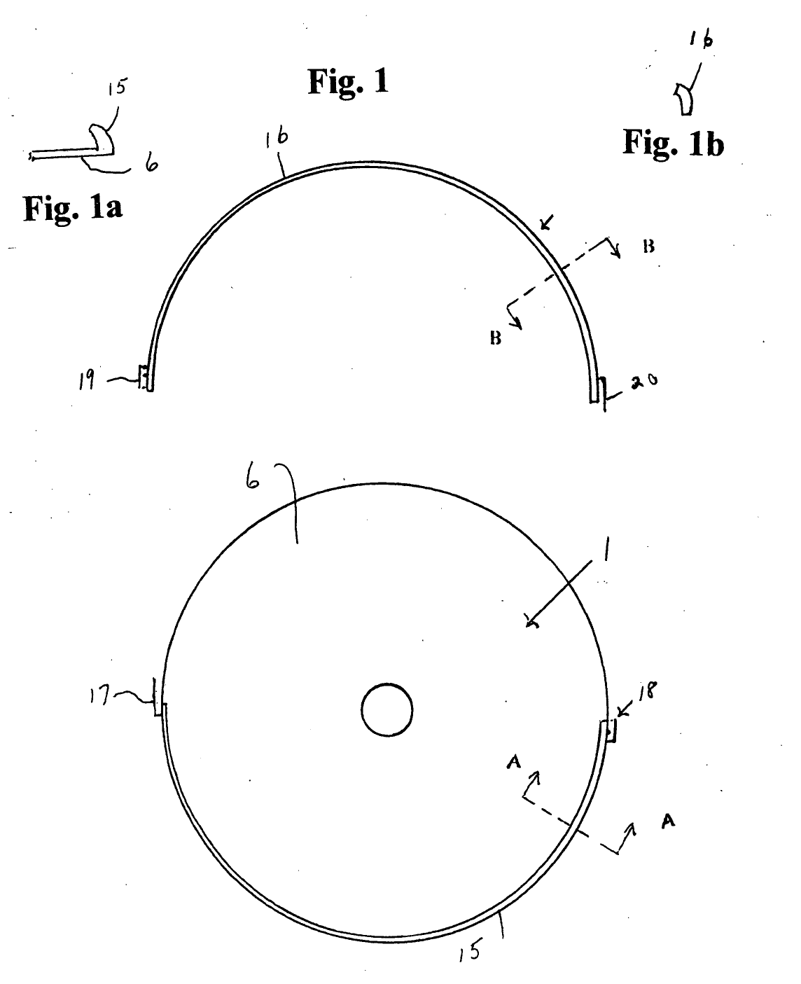

The embodiment as shown in FIGS. 1-1b has a semicircular ring 15 attached to the disc 6 of the protector cover and another semicircular ring attaches to the first semicircular ring by means of a pair of box clasps. The disc of the protective cover is made of a rigid transparent plastic and is substantially the same circumference as a CD or DVD disc. It is about half the thickness of a CD or DVD disc. The semicircular ring 15 which is attached to the protective disc is about one and a half the height of a CD or DVD disc and is concave. At both ends of this semicircular ring is a box clasp tongue 17, 18, shown schematically in FIG. 1, that will mate with a box clasp hole 19, 20, in a second semicircular ring 16.

The second semicircular ring 16 is concave as shown in FIG. 1b so that the concavity can accept both the protective disc and the CD or DVD. This semicircular ring goes over the outer circumference of both the CD or DVD disc and disc protector. It is also about one and a half the height of a CD or DVD disc. At both ends of this semicircular ring is a box clasp hole 19, 20 that will mate with the box clasp tongues 17, 18 on the semicircular ring 15 which is attached to the disc of the protector. Of course, the tongues and holes could be mounted on the opposite semicircular rings if desired, or they could be mixed so that each semicircular ring has one of each.

The semicircular ring 15 on the disc of the protector, and the separate semicircular ring 16 are only wide or thick enough to allow for a box clasp locking mechanism to be mounted thereon.

To use the disc protector, a CD or DVD disc is placed onto the disc of the protector. The CD or DVD disc fits against the disc of the protector 1 and its semicircular ring 15, and concaved semicircular ring 16 is then attached to the disc protector. The read\write side of the CD or DVD disc faces downwardly against the disc protector. The separate semicircular ring 16 goes over both the CD or DVD disc and disc of the protector. The box clasp tongues 17, 18 will lock into place with the box clasp holes 19, 20 on the separate semicircular ring. The box clasp locking mechanism, along with the concave semicircular ring will prevent the CD or DVD disc and the disc protector from separating.

To remove the disc protector, a person presses against both box clasp tongues and removes the separate semicircular ring 16. The CD or DVD can then be taken out of the disc protector 1 and placed on a new protector so that the CD or DVD disc always remains protected and does not become scratched.

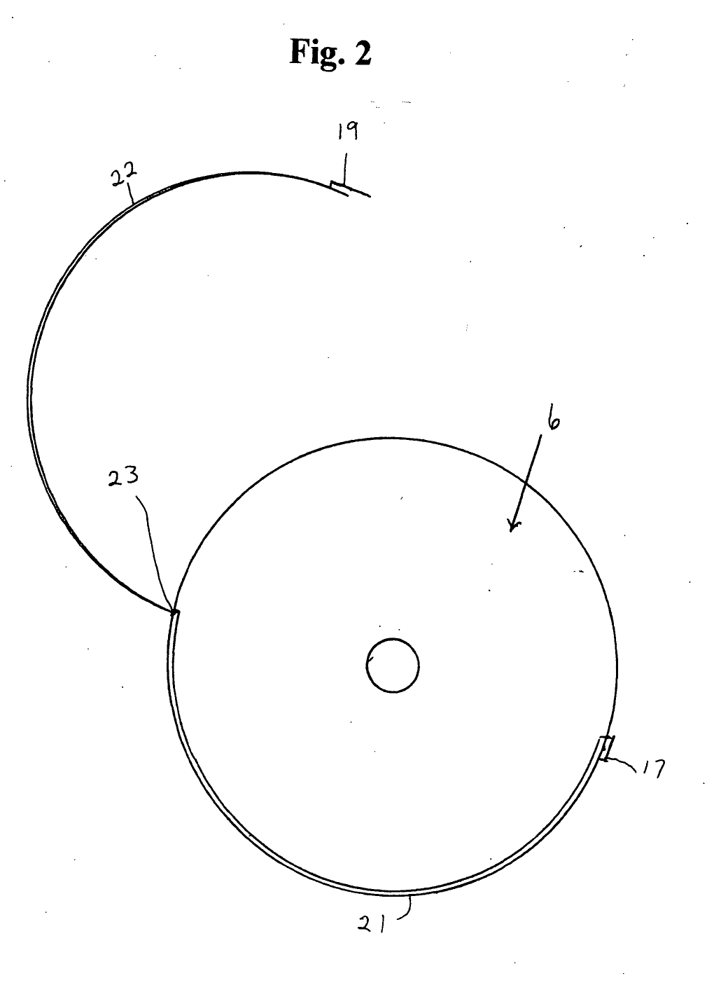

The embodiment of FIG. 2 has a disc protector that consists of two parts: a rigid removable transparent plastic disc 6 that is substantially the same circumference as a CD or DVD disc and is about half the thickness of a CD or DVD disc. It has a plastic retaining ring. The ring is the same circumference as a CD or DVD disc and is about one and a half the height of a CD or DVD disc and is concave. The ring consists of two semi-circles 21 and 22 which are attached to each other at one end of each by a hinge 23. At the other end of the two semicircular rings is a box clasp 17, 19. One of the semicircular rings has a tongue and the other has a box clasp hole.

To use the disc protector, a CD or DVD disc is placed onto the disc protector so that it contacts the concave side of the first semicircular ring 21, then the other semicircular ring 22 is swung over the other half of the CD or DVD disc and disc protector. The box clasp tongue on one of the semicircular rings can then lock into place with the box clasp hole of the other semicircular ring.

The box clasp locking mechanism, along with the concave semicircular rings, will then prevent the CD or DVD disc and disc protector from separating.

To remove the disc protector, the box clasp tongue is released from the hole, and the second semicircular ring 22 can be swung away.

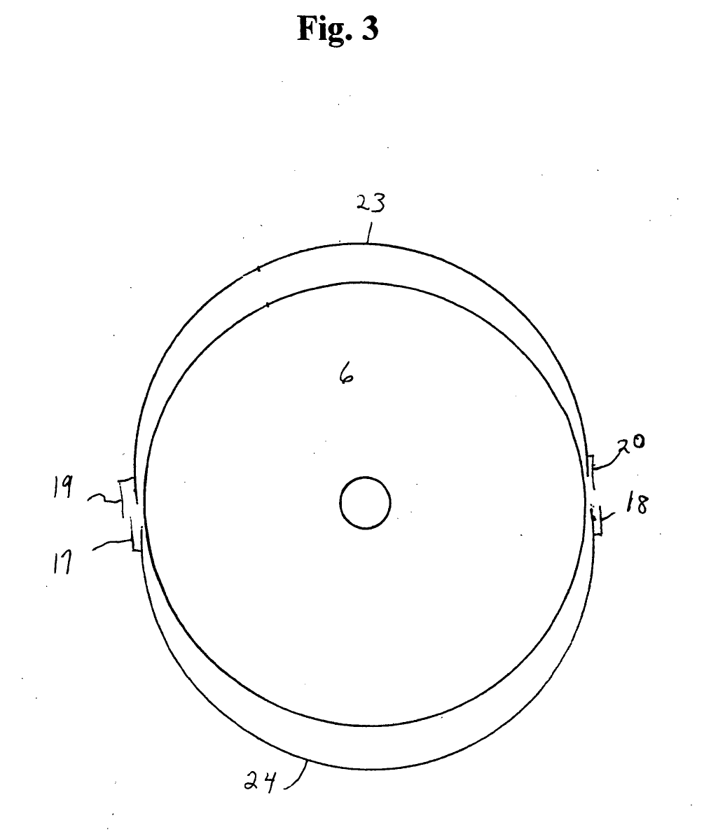

In FIG. 3 the disc protector is shown as consisting of three parts: a rigid removable transparent plastic disc 6 that is substantially the same circumference as a CD or DVD disc and is about half the thickness of a CD or DVD disc, an outer semicircular ring 23 with a box clasp hole 19, 20 at both ends, and another outer semicircular ring 24 with a box clasp tongue 17, 18 at both ends of this outer semicircular ring. The two semicircular rings are about one and a half the height of a CD or DVD disc and are concave so they will hold the disc and disc protector together and not fall off from the disc and disc protector.

To use this disc protector, the read\write side of a CD or DVD disc is placed onto the disc 6 of the protector and one of the semicircular rings is slipped around the outer circumference of both the CD or DVD disc and disc protector. The other semicircular ring around the outer circumference of the other half of the CD or DVD disc and disc protector. The box clasp tongues on one ring can then lock into place with the box clasp holes of the other ring. The box clasp locking mechanism along with the concave semicircular rings will prevent the CD or DVD disc and disc protector from separating.

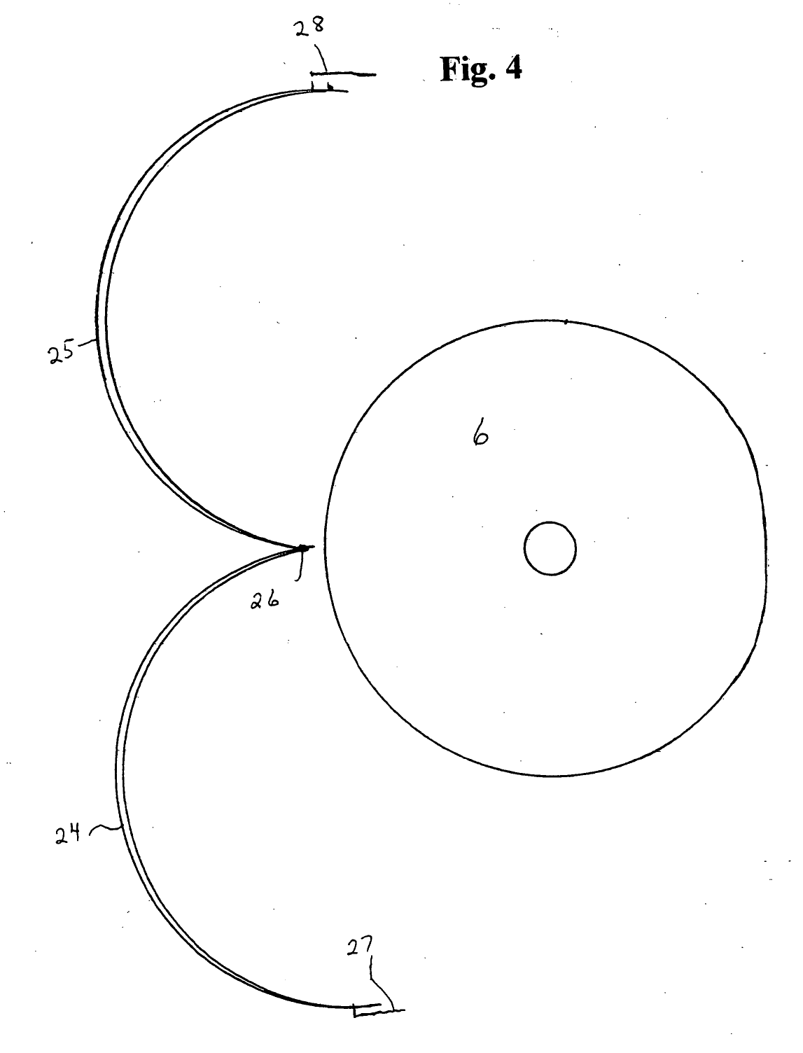

The structure shown in FIG. 4 has a disc protector cover which is made of a rigid removable transparent plastic disc 6 that is substantially the same circumference as a CD or DVD disc. It is about half the thickness of a CD or DVD disc. The disc protector has two semicircular rings 24, 25. The semicircular rings are about one and a half times the height of a CD or DVD disc and are concave in their cross section so that they will engage and hold the protective disc and CD or DVD together. At one end of each semicircular ring is hinge 26 which attaches it to the other semicircular ring. At the other end of one of the semicircular rings is a box clasp tongue 27 that will be accepted into a box clasp 28 hole in the other end of the other semicircular ring. The box clasp locking mechanism along with the concave semicircular rings will lock both the CD or DVD disc and disc protector into place.

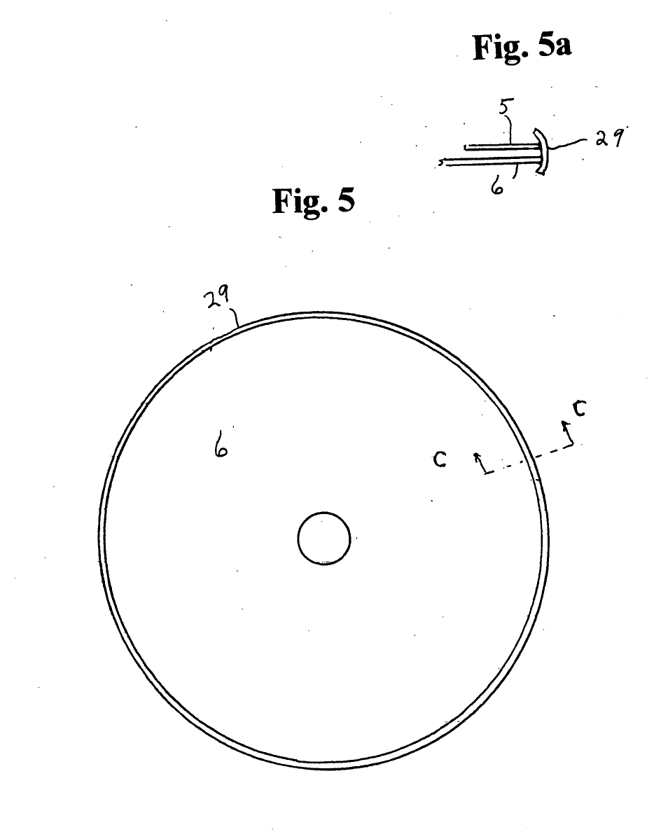

This embodiment of the disc protector shown in FIG. 5 consists of two parts: a rigid removable transparent plastic disc 6 that is substantially the same circumference as a CD or DVD disc and is about half the thickness of a CD or DVD disc, and a flexible plastic retaining ring 29. The ring 29 is the same circumference as a CD or DVD disc and is about one and a half the height of a CD or DVD disc. The ring 29 is concave in its cross section as shown in FIG. 5a so that it will hold and retain the protective disc 6 to the CD or DVD 5.

To use this disc protector, the read\write side of a CD or DVD disc 5 is placed onto the disc 6. Then a part of the flexible plastic retaining ring 29 is slipped over and around a portion of the edges of both the CD or DVD 5 disc and disc 6 of the protector. The flexible plastic retaining ring 29 is then slipped over and around the rest of the CD or DVD disc and disc protector. By lightly pulling back on the flexible plastic retaining ring and continuing to slip the ring over and around the CD or DVD disc and disc protector.

The inward contracting force of the flexible plastic retaining ring keeps the CD or DVD disc 5 and disc 6 of the protector from separating. This disc protector can be removed by pulling back on a portion of the flexible plastic retaining ring while slipping the CD or DVD disc and disc protector out from the ring.

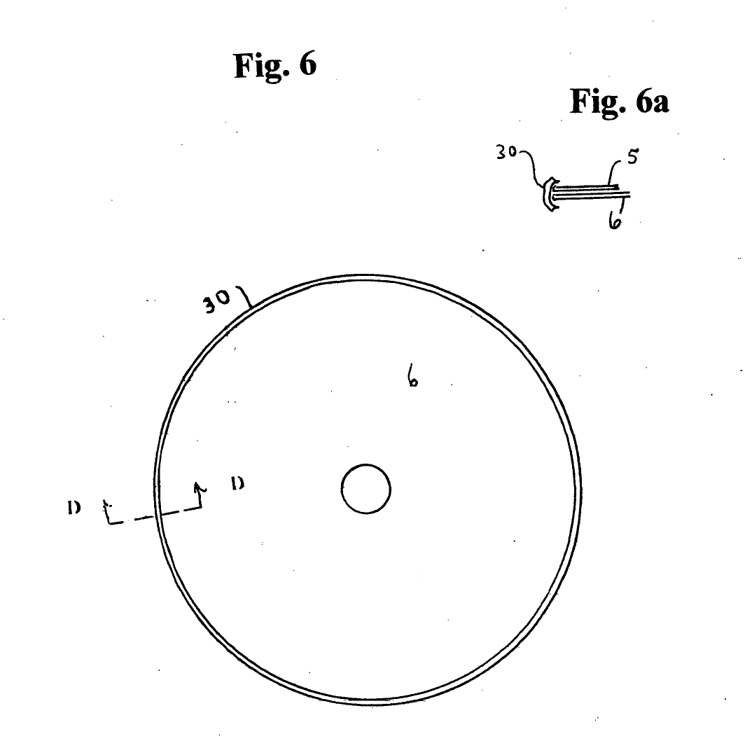

The embodiment of the disc protector shown in FIGS. 6 and 6a consists of two parts: a rigid removable transparent plastic disc 6 that is substantially the same circumference as a CD or DVD disc 5 and is about half the thickness of a CD or DVD disc, and a ring 30 of heat-shrinkable material. The heat-shrinkable material ring 30 is the same circumference as a CD or DVD disc and is about one and a half the height of a CD or DVD disc and is concave in its cross section. The disc protector can be placed on a CD or DVD by placing the read\write side of a CD or DVD disc onto the disc protector and slipping a part of the heat-shrinkable material ring over and around a portion of both the CD or DVD disc and disc protector. As the heat-shrinkable material is slipped over and around the CD or DVD disc and disc protector, the heat-shrinkable material is lightly pulled and continued to be slipped over and around the rest of the CD or DVD disc and disc protector. Then gentile heat is applied to the heat-shrinkable material of the ring until its material is contracted.

The contraction of the heat-shrinkable material of the ring holds the CD or DVD disc and disc protector together. This protector can be removed by pulling off the heat-shrinkable material. This protector can then be replaced with a new one.

As an alternative, the heat shrinkable material could also be manufactured integrally with the plastic disc protector.

while the material of the rings has not been specified, they can be made of metal, plastic, or any other appropriate material.

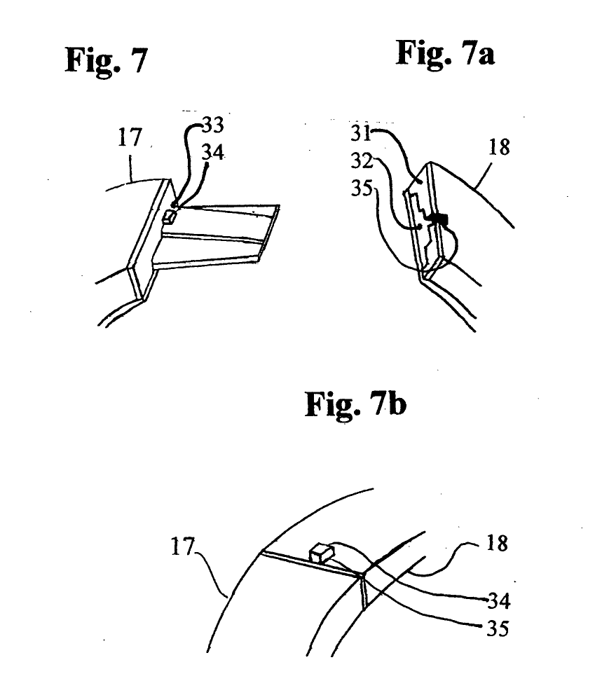

Each of the embodiments shown in FIGS. 14 requires one or more clasp mechanisms, which are shown in greater detail in FIGS. 7-7b. As can be seen, each clasp mechanism has a tongue portion 17, duplicated as 20, 27 in FIGS. 1 and 4, plus a hole portion 18, duplicated as 19, 28 in FIGS. 1 and 4, which accepts and holds the respective tongue portion 17, 20 or 27. Each hole portion includes a front wall 31 which has an opening 32. Further, each tongue portion has a ledge 33 which engages the back surface of the wall 31 after the tongue portion has been inserted into the hole portion. This engagement of the ledge 33 with the back surface of the wall 31 keeps the clasp engaged and holds the two portions together. The tongue portion also includes a protrusion 34 which extends perpendicularly from the tongue portion and extends through an additional hole 35. When the two clasp portions are engaged and held together, the protrusion 34, because it extends through the hole 35, can be pushed so as to disengage the ledge 33 from the back surface of the wall 31 and thus disengage the two clasp portions 17 and 18.

The foregoing relates to preferred exemplary embodiment of the invention, it being understood that other variants and embodiments thereof are possible within the spirit and scope of the invention, the latter being defined by the appended claims.

We claim:

1. A protector for use with an optical data disc, which protector protects the data disc from: scratches or other damage which might prevent an optical data disc reader from reading the data on the data disc, the protector including a transparent protector disc which is substantially the same diameter as the data disc, and means for holding the data disc to the protector disc, the means for holding including a ring which engages the circumferential edge of the data disc and thereby holds the data disc in position with its data surface adjacent to a surface of the protector disc and thus protected thereby, so that the data on the data disc can be read through the transparent protector disc, the means for holding the data disc being releasable so that the data disc can be removed form the protector disc, wherein the ring is a pair of semicircular ring sections which can be connected and when connected surround the circumference of the data disc and hold it to the protector disc.

2. A protector for use with an optical data disc as recited in claim 1, wherein one of the semicircular ring sections is permanently attached to the protector disc.

3. A protector for use with an optical data disc as recited in claim 1, wherein the semicircular ring sections are attached to each other at one end by a hinge.

4. A protector for use with an optical data disc as recited in claim 2, wherein the semicircular ring sections are attached to each other at one end by a hinge.

5. A protector for use with an optical data disc as recited in claim 3, wherein the semicircular ring sections are attached to each other at their other ends by a clasp mechanism.

6. A protector for use with an optical data disc as recited in claim 4, wherein the semicircular ring sections are attached to each other at their other ends by a clasp mechanism.

7. A protector for use with an optical data disc as recited in claim 1, wherein the semicircular ring sections are attached to each other at both ends by a clasp mechanism.

8. A protector for use with an optical data disc as recited in claim 2, wherein the semicircular ring sections are attached to each other at both ends by a clasp mechanism.

9. A protector for use with an optical data disc as recited in claim 5, wherein the clasp mechanism includes a first portion which has a tongue, and a second portion which receives and releasably holds the tongue of the first portion.

10. A protector for use with an optical data disc as recited in claim 6, wherein the clasp mechanism includes a first portion which has a tongue, and a second portion which receives and releasably holds the tongue of the first portion.

11. A protector for use with an optical data disc as recited in claim 7, wherein each of the clasp mechanisms includes a first portion which has a tongue, and a second portion which receives and releasably holds the tongue of the first portion.

12. A protector for use with an optical data disc as recited in claim 1, wherein each of the ring sections includes a concave portion that engages both the data disc and the protector disc.

13. A protector for use with an optical data disc as recited in claim 3, wherein each of the ring sections includes a concave portion that engages both the data disc and the protector disc.

14. A protector for use with an optical data disc as recited in claim 2, wherein the other ring section includes a concave portion that engages both the data disc and the protector disc.

15. A protector for use with an optical data disc as recited in claim 8, wherein the other ring section includes a concave portion that engages both the data disc and the protector disc.

16. A protector for use with an optical data disc, which protector protects the data disc from. scratches or other damage which might prevent an optical data disc reader from reading the data on the data disc, the protector including a transparent protector disc which is substantially the same diameter as the data disc, and means for holding the data disc in registration with the protector disc with the data surface of the data disc adjacent to a surface of the protector disc so that the data thereon is thus protected by the protector disc and the data on the data disc can be read through the transparent protector disc, the means for holding being in the form of a ring which includes a concave portion which engages the edge of both the data disc and the protector disc, wherein the ring is made of a heat shrink material so that after the ring is positioned around the data disc and the protector disc it can be shrunk by application of heat and thus hold the data disc to the protector disc.
